(19) United States
(12) Patent Application Publication
(10) Pub. No.: US 2026/0254153 A1
(43) Pub. Date: Aug. 27, 2026

(54) TERMINAL BLOCK AND TERMINAL BLOCK UNIT

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Yasuhiro KUDO, Yokkaichi-shi (JP); Kentaro TACHI, Yokkaichi-shi (JP); Daisuke HASHIMOTO, Yokkaichi-shi (JP); Yoshitomo TSUJII, Yokkaichi-shi (JP)

(73) Assignees: AUTONETWORKS TECHNOLOGIES, LTD., Yokkaichi-shi, Mie (JP); SUMITOMO WIRING SYSTEMS, LIMITED, Yokkaichi-shi, Mie (JP); SUMITOMO ELECTRIC INDUSTRIES, LTD., Osaka-shi, Osaka (JP)

(21) Appl. No.: 18/725,419

(22) PCT Filed: Dec. 26, 2022
(86) PCT No.: PCT/JP2022/047820

§ 371 Date: Jun. 28, 2024

(30) Foreign Application Priority Data
Jan. 11, 2022 (JP) 2022-002400

(51) Int. Cl. H01R 13/52; H01R 9/16; H01R 9/22

(52) U.S. Cl. CPC H01R 13/5202; H01R 9/16; H01R 9/223

(57) ABSTRACT

A terminal block including: a terminal block body including one or more terminals each having two ends serving as electrical connection points, the terminal block body being configured to be attached to a case by being fitted to an attachment portion of the case; and an annular elastic seal arranged to seal a connection between the attachment portion and the terminal block body, wherein: the terminal block body further includes a protrusion configured to press and fix the elastic seal against a flat attachment surface of the attachment portion without moving the elastic seal in an attachment direction during attachment to the attachment portion, and the elastic seal includes a compression portion configured to be squashed and pressed against the attachment surface by the protrusion during attachment.

### BACKGROUND

The present disclosure relates to a terminal block and a terminal block unit.

Conventionally, a terminal block having a relay connector function for electrically connecting a component inside a case to a component outside the case is known (e.g., see JP 2014-232601A). The terminal block of JP 2014-232601A is attached by fitting a portion thereof into a circular hole portion formed in the case. This terminal block has a sealing member that ensures sealing between the case and the terminal block body. The sealing member is attached to a groove extending along the peripheral direction in the peripheral surface of the terminal block body.

### SUMMARY

In the case where the case is a cast product, for example, the surface of the case, which is a cast surface, has a rough texture. Therefore, in order to ensure air tightness with the seal member, the circular hole portion of the case needs to be subjected to sealing surface processing by cutting performed with a blade. However, when this sealing surface processing is performed, the cavity (space) inside the case, which is a cast product, may be exposed to the outside. For this reason, when the sealing member is set on the terminal block body and the terminal block body is inserted into the case, the sealing member may be damaged due to coming into contact with a sharp edge of the cavity while sliding through the circular hole portion of the case. Therefore, there has been a possibility that sufficient sealing performance could not be ensured.

An exemplary aspect of the disclosure provides a terminal block and a terminal block unit that can improve the sealing performance between the terminal block and the case.

In order to solve the foregoing problems, a terminal block according to an aspect of the present disclosure includes: a terminal block body including one or more terminals each having two ends serving as electrical connection points, the terminal block body being configured to be attached to a case by being fitted to an attachment portion of the case; and an annular elastic seal arranged to seal a connection between the attachment portion and the terminal block body, wherein: the terminal block body further includes a protrusion configured to press and fix the elastic seal against a flat attachment surface of the attachment portion without moving the elastic seal in an attachment direction during attachment to the attachment portion, and the elastic seal includes a compression portion configured to be squashed and pressed against the attachment surface by the protrusion during attachment.

In order to solve the foregoing problems, a terminal block unit according to an aspect of the present disclosure includes: a terminal block body including one or more terminals each having two ends serving as electrical connection points; and a case including an attachment portion to which the terminal block is attachable, wherein: the terminal block includes: a terminal block body configured to be attached to the case by being fitted to the attachment portion; and an annular elastic seal arranged to seal a connection between the attachment portion and the terminal block body, the terminal block body further includes a protrusion configured to press and fix the elastic seal against a flat attachment surface of the attachment portion without moving the elastic seal in an attachment direction during attachment to the attachment portion, and the elastic seal includes a compression portion configured to be squashed and pressed against the attachment surface by the protrusion during attachment.

According to the present disclosure, it is possible to improve the sealing performance between a terminal block and a case.

### BRIEF DESCRIPTION OF THE DRAWINGS

FIG. 1 is a perspective view of a terminal block unit.

FIG. 2 is a partially enlarged cross sectional view of the terminal block unit.

FIG. 3 is an exploded perspective view of the terminal block unit.

FIG. 4 is a cross-sectional view of the terminal block unit before an elastic member is squashed.

FIG. 5 is a cross sectional view of the terminal block unit after the elastic member is squashed.

FIG. 6 is a perspective view of attachment of the terminal block to an attachment portion of a case.

FIG. 7 is a perspective view of the terminal block after insertion into a recessed portion of the attachment portion.

FIG. 8 is a transition diagram showing a process of squashing the elastic member.

FIG. 9 is a cross sectional view of the terminal block unit when using an elastic member having a different shape.

FIG. 10 is a cross sectional view of the terminal block unit showing a state of the elastic member when force acting in a detachment direction is applied to the terminal block body.

### DETAILED DESCRIPTION OF EMBODIMENTS

First, embodiments of the present disclosure will be listed and described.
(1) In order to solve the foregoing problems, a terminal block according to an aspect of the present disclosure includes a terminal block body including one or more terminals each having two ends serving as electrical connection points, and configured to be attached to a case by being fitted to an attachment portion of the case, and an annular elastic member arranged to seal a connection between the attachment portion and the terminal block body. The terminal block body further includes a protrusion portion configured to press and fix the elastic member against a flat attachment surface of the attachment portion without moving the elastic member in an attachment direction during attachment to the attachment portion, and the elastic member includes a compression portion configured to be squashed and pressed against the attachment surface by the protrusion portion during attachment.

According to the configuration of this example, when the terminal block is attached, the elastic member is fixed to the attachment surface by being squashed by the protrusion portion of the terminal block body without moving in the attachment direction. In this way, in this example, a structure is adopted in which the elastic member is attached while being pressed against the attachment surface and undergoing elastic deformation. Therefore, during attachment, the elastic member does not slide on the surface of the attachment portion. This therefore suppresses, for example, a problem that may occur when the case is a cast product, that is to say a situation in which, during attachment, the elastic member is damaged by a cavity that appears due to sealing surface processing. Therefore, the sealing performance between the terminal block and the case can be improved.
(2) An aspect is possible in which the elastic member further includes a catch portion configured to be caught on an upper surface of the attachment portion during attachment. According to this configuration, during attachment, the catch portion of the elastic member can be caught on the attachment portion, and the elastic member can be positioned in the attachment direction. Therefore, it is possible to suppress the occurrence of a situation in which the elastic member moves in the attachment direction during attachment.
(3) An aspect is possible in which the protrusion portion has a force point at which the elastic member is pressed against the attachment surface during attachment, the catch portion has a support point of movement of the compression portion in elastic deformation due to being pressed by the protrusion portion at the force point, and in an initial state before attachment, the force point is located on a near side in the attachment direction and the support point is located on a far side in the attachment direction. According to this configuration, when the elastic member is pressed by the protrusion portion at the force point during attachment, it is possible to press the elastic member against the attachment surface with the support point of the catch portion serving as the basis. Therefore, during attachment, the elastic member can be firmly fixed to the attachment surface without being moved in the attachment direction.
(4) An aspect is possible in which the terminal block body further includes a seat portion on which a distal end of the compression portion is placed in an initial state before attachment. According to this configuration, it is possible to suppress the case where the elastic member separates from the terminal block body before attachment.
(5) An aspect is possible in which the protrusion portion further includes a flat pressing portion configured to, along with the attachment surface, sandwich and support the elastic member during attachment. According to this configuration, the elastic member can be sandwiched and held between the flat attachment surface and the pressing portion. Therefore, the elastic member can be attached and fixed in close contact between the attachment surface and the protrusion portion without any gaps. This therefore further contributes to improving the sealing performance of the elastic member.
(6) An aspect is possible in which the protrusion portion includes an inclined surface portion configured to squash the compression portion during attachment. According to this configuration, when the terminal block is attached, the elastic member can gradually undergo elastic deformation due to being pressed by the inclined surface portion of the protrusion portion. Therefore, when fitting the terminal block into the attachment portion, no excessive load is applied, and thus the terminal block can be smoothly attached to the attachment portion with appropriate force.
(7) An aspect is possible in which the compression portion includes a base end portion having an inclined surface configured to come into contact with the inclined surface portion of the terminal block body, and a thick wall portion extending distally from the base end portion and thicker than the base end portion. According to this configuration, the thick wall portion is provided in the compression portion, thus making it possible to provide a larger area of engagement when the protrusion portion of the terminal block body comes into contact during attachment. Therefore, it is possible to firmly bring the elastic member into close contact with the attachment portion of the case. This therefore further contributes to improving the sealing performance of the elastic member.
(8) An aspect is possible in which the thick wall portion includes: a first contact surface configured to come into contact with the attachment surface during attachment; and a second contact surface on a side opposite to the first contact surface and configured to come into contact with the terminal block body during attachment, and the second contact surface is longer than the inclined surface in an axial direction of the elastic member. According to this configuration, the second contact surface of the elastic member can be larger, thus making it possible to ensure a sufficient amount of surface pressure applied to the elastic member by the protrusion portion during attachment. This further contributes to firmly attaching the elastic member to the attachment surface.
(9) An aspect is possible in which the compression portion is non parallel with the attachment surface so as to form an angle with the attachment surface. According to this configuration, the elastic member is shaped such that the compression portion is closer to the terminal block body. Therefore, the incident angle, which is the angle formed by the attachment surface of the attachment portion and the inclined surface of the elastic member, can be made smaller without greatly changing the area of the pressing portion, which is the portion of the protrusion portion that presses the elastic member. Therefore, it is possible to both firmly fix the elastic member to the attachment surface and smoothly attach the terminal block with appropriate force.
(10) An aspect is possible in which a distal end of the compression portion has a quadrangular shape in cross section. According to this configuration, in the case where the terminal block attempts to move in a direction of detachment from the attachment portion, it is possible to generate, in the distal end of the elastic member (compression portion), repulsive force acting in an oblique direction for pressing the distal end against the terminal block body. Therefore, even if the terminal block attempts to move in a direction of detachment from the attachment portion, the elastic member can be kept in place. This therefore further contributes to improving the sealing performance of the elastic member.
(11) In order to solve the foregoing problems, a terminal block unit according to an aspect of the present disclosure includes a terminal block body including one or more terminals each having two ends serving as electrical connection points, and a case including an attachment portion to which the terminal block is attachable. The terminal block includes a terminal block body configured to be attached to the case by being fitted to the attachment portion, and an annular elastic member arranged to seal a connection between the attachment portion and the terminal block body; the terminal block body further includes a protrusion portion configured to press and fix the elastic member against a flat attachment surface of the attachment portion without moving the elastic member in an attachment direction during attachment to the attachment portion; and the elastic member includes a compression portion configured to be squashed and pressed against the attachment surface by the protrusion portion during attachment. According to this configuration, actions and effects similar to those of the terminal block can be obtained.

### Details of Embodiments of Present Disclosure

Specific examples of the present disclosure will be described below with reference to the drawings. Note that the present disclosure is not limited to these examples, but rather is indicated by the scope of the claims, and is intended to include all changes within the meaning and scope equivalent to the scope of the claims. In the drawings, parts of configurations may be exaggerated or simplified for convenience of description. Furthermore, the dimensional ratios of parts may also differ from actual dimensional ratios.

### Configuration of Terminal Block Unit 1

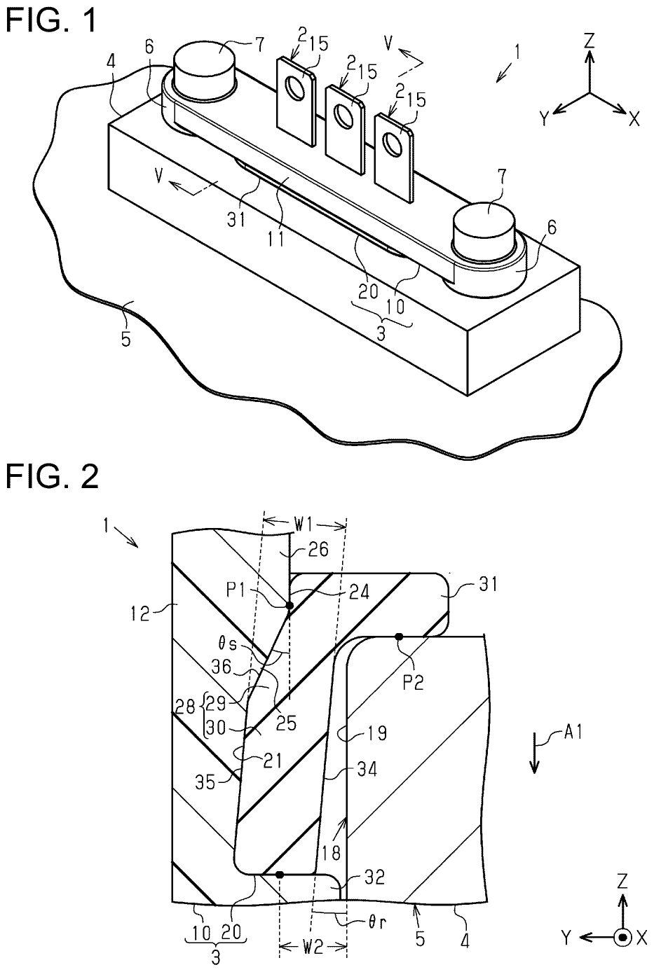

As shown in FIG. 1, the terminal block unit 1 includes a terminal block 3 having one or more terminals 2 each having two ends serving as electrical connection points, and a case 5 having an attachment portion 4 for attachment of the terminal block 3. In this example, a plurality of (three) terminals 2 are provided. These terminals 2 are arranged in alignment in the length direction of the terminal block 3 (X-axis direction in FIG. 1). The terminal block 3 is attached to the case 5 by fixing two ends 6 to the attachment portion 4 using fastening portions 7. The fastening portions 7 are bolts, for example.

### Configuration of Terminal Block 3

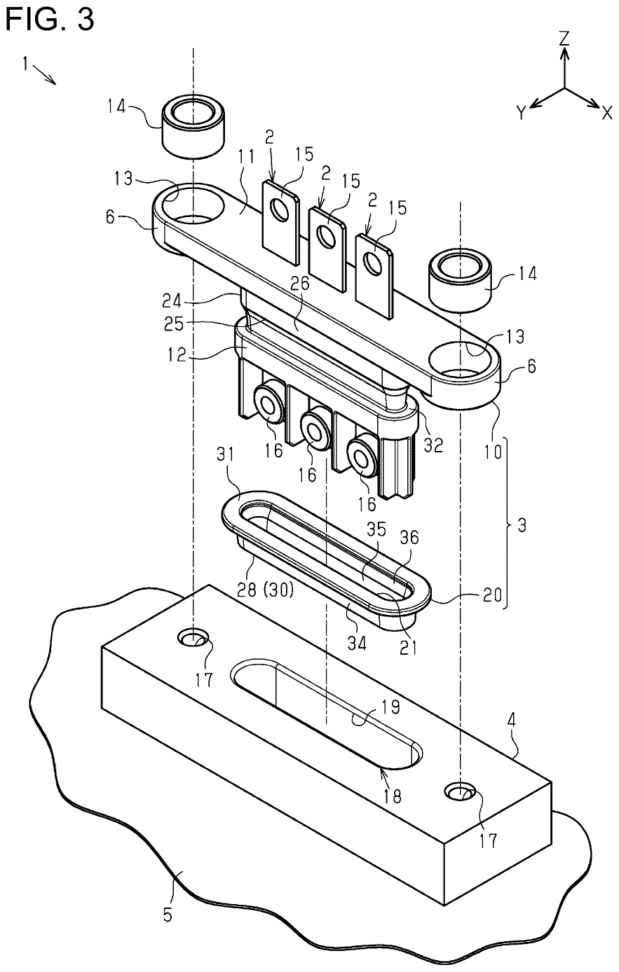

As shown in FIG. 3, the terminal block 3 includes a terminal block body 10 that is attached to the case 5 by being fitted to the attachment portion 4. The terminal block body 10 is formed by molding in which the terminals 2 are loaded into a mold and resin is injected into the mold. The terminal block body 10 includes a first body 11 located outside the attachment portion 4 when attached, and a second body 12 located inside the attachment portion 4 when attached. Through holes 13 for insertion of the fastening portions 7 are formed in the two ends 6 of the first body 11. The shaft portions of the fastening portions 7 are inserted into the through holes 13 via annular collars 14.

The terminals 2 are formed so as to extend across both the first body 11 and the second body 12. Each of the terminals 2 has a first terminal portion 15 exposed to the outside on the first body 11 side and a second terminal portion 16 exposed to the outside on the second body 12 side. The first terminal portion 15 and the second terminal portion 16 serve as electrical connection points of the terminal 2.

A pair of fastening holes 17 for attaching the shaft portions of the fastening portions 7 are provided in the two lengthwise ends of the attachment portion 4. The attachment portion 4 includes a recessed portion 18 into which the terminal block 3 (specifically, the second body 12 of the terminal block body 10) is inserted. In this example, the recessed portion 18 is shaped as an elongated hole. The two lengthwise ends (two ends in the X-axis direction in FIG. 3) of the recessed portion 18 are substantially arc-shaped. The case 5 (attachment portion 4) is formed by casting. In this example, the inner peripheral surface of the recessed portion 18 is not subjected to sealing surface processing, and has the same shape as after casting. In this way, the attachment portion 4 has a flat attachment surface 19 at the location where the terminal block 3 is attached.

### Configuration of Elastic Member 20

The terminal block 3 includes an annular elastic member 20 (annular elastic seal) arranged to seal the connection between the attachment portion 4 and the terminal block body 10. The elastic member 20 is a rubber packing made of an acrylic material, a silicone material, or the like, for example. The second body 12 is inserted through a hole portion 21 of the elastic member 20 for attachment to the terminal block body 10. In this manner, the elastic member 20 is in a state of being attached to the terminal block body 10 (second body 12) in the initial state before assembly. The elastic member 20 is a shaft sealing member provided at the location where the terminal block body 10 is inserted into the recessed portion 18 of the attachment portion 4.

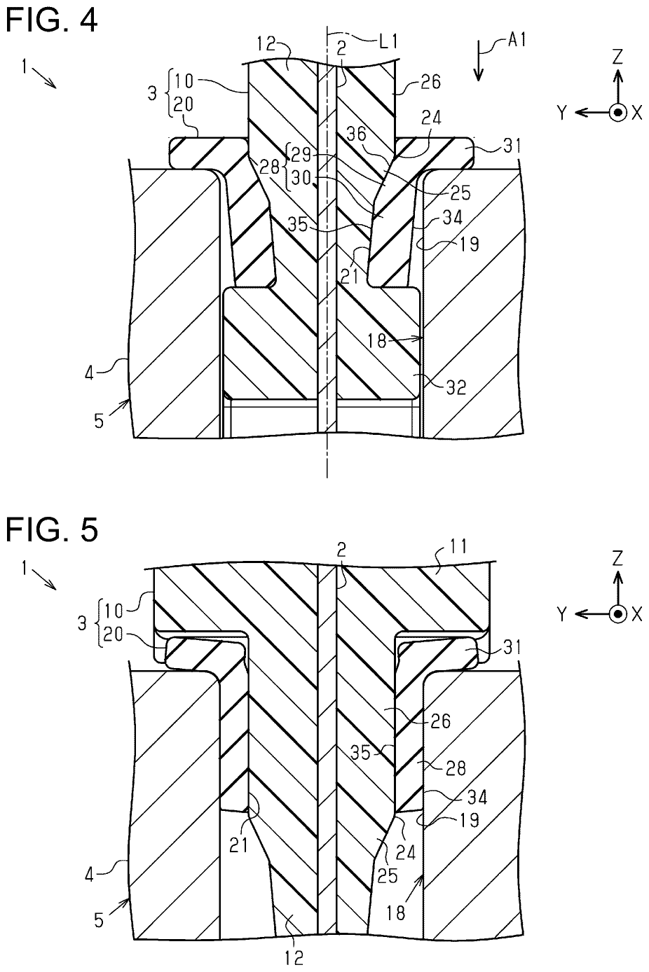

Mechanism for squashing elastic member 20 during attachment FIG. 4 is a diagram showing a state before the terminal block 3 is attached to the attachment portion 4. FIG. 5 is a diagram showing a state after the terminal block 3 is attached to the attachment portion 4. As shown in FIGS. 4 and 5, the terminal block body 10 has a protrusion portion 24 (protrusion) that presses and fixes the elastic member 20 against the flat attachment surface 19 of the attachment portion 4 without moving the elastic member 20 in the attachment direction (arrow Al direction in FIG. 4) when attached to the attachment portion 4. The protrusion portion 24 is provided on the second body 12 and is formed completely around the outer peripheral surface of the second body 12 in the peripheral direction.

The protrusion portion 24 has an inclined surface portion 25 (inclined surface) that squashes the elastic member 20 during attachment. In this manner, when attaching the terminal block 3, the elastic member 20 is squashed by the inclined surface portion 25 of the protrusion portion 24, and thus the elastic member 20 is brought into close contact with the attachment portion 4.

The protrusion portion 24 has a flat pressing portion 26 that, together with the attachment surface 19 of the attachment portion 4, sandwiches and supports the elastic member 20 during attachment. It is preferable that the pressing portion 26 is a surface parallel with the attachment surface 19, for example. If the pressing portion 26 can be formed with a certain length in the axial direction of the elastic member 20 (axis L1 direction in FIG. 4), high surface pressure can be ensured when the elastic member 20 is sandwiched between the pressing portion 26 and the attachment surface 19.

The elastic member 20 has a compression portion 28 that is squashed and pressed against the attachment surface 19 by the protrusion portion 24 during attachment. The compression portion 28 is formed completely around the annular elastic member 20 in the peripheral direction. When the terminal block 3 is attached, the compression portion 28 is squashed by the inclined surface portion 25 of the protrusion portion 24. Before being squashed, the compression portion 28 has a base end portion 29 (base end) that is inclined and comes into contact with the inclined surface portion 25 of the terminal block body 10, and a thick wall portion 30 (thick wall) that extends distally from the base end portion 29 and is thicker than the base end portion 29. The distal end of the compression portion 28 (thick wall portion 30) has a quadrangular shape in cross section.

The elastic member 20 has a catch portion 31 that is caught on the upper surface of the attachment portion 4 during attachment. The catch portion 31 is formed completely around the annular elastic member 20 in the peripheral direction. The catch portion 31 extends in a direction intersecting the compression portion 28. For this reason, the elastic member 20 is substantially shaped as a capital “L” in cross section.

The terminal block body 10 has a seat portion 32 (seat) on which the distal end of the compression portion 28 is placed in an initial state before attachment. In this manner, the elastic member 20 is in a state in which the distal end of the thick wall portion 30 rests on the seat portion 32 in the initial state before attachment.

Design features of mechanism for squashing elastic member 20 As shown in FIG. 2, the protrusion portion 24 has a force point P1 at which the elastic member 20 is pressed against the attachment surface 19 during attachment. The catch portion 31 has a support point P2 of movement of the compression portion 28 in elastic deformation due to being pressed by the protrusion portion 24 at the force point P1. In the initial state before attachment, the force point P1 is located on the near side in the attachment direction (arrow A1 direction in FIG. 2), and the support point P2 is located on the far side in the attachment direction (o arrow A1 direction in FIG. 2).

The compression portion 28 is formed so as to be non-parallel with the attachment surface 19, that is to say so as to form an angle Or with the attachment surface 19. In other words, by shaping the compression portion 28 so as to be closer to the terminal block body 10, the angle θr is formed between the compression portion 28 and the attachment surface 19. Also, the amount of compression that the compression portion 28 undergoes when squashed is obtained by subtracting the length of a gap W2 between the attachment surface 19 and the pressing portion 26 from a width W1 of the thick wall portion 30 in the figure (W1-W2).

The thick wall portion 30 has a first contact surface 34 that comes into contact with the attachment surface 19 during attachment, and a second contact surface 35 that is located on the side opposite to the first contact surface 34 and comes into contact with the terminal block body 10 during attachment. It is preferable that the first contact surface 34 and the second contact surface 35 are parallel with each other. The second contact surface 35 is longer than an inclined surface 36 of the base end portion 29 in the axial direction of the elastic member 20 (axis L1 direction).

Next, operations of the terminal block 3 (terminal block unit 1) of the present embodiment will be described.

### Attachment of Terminal Block 3

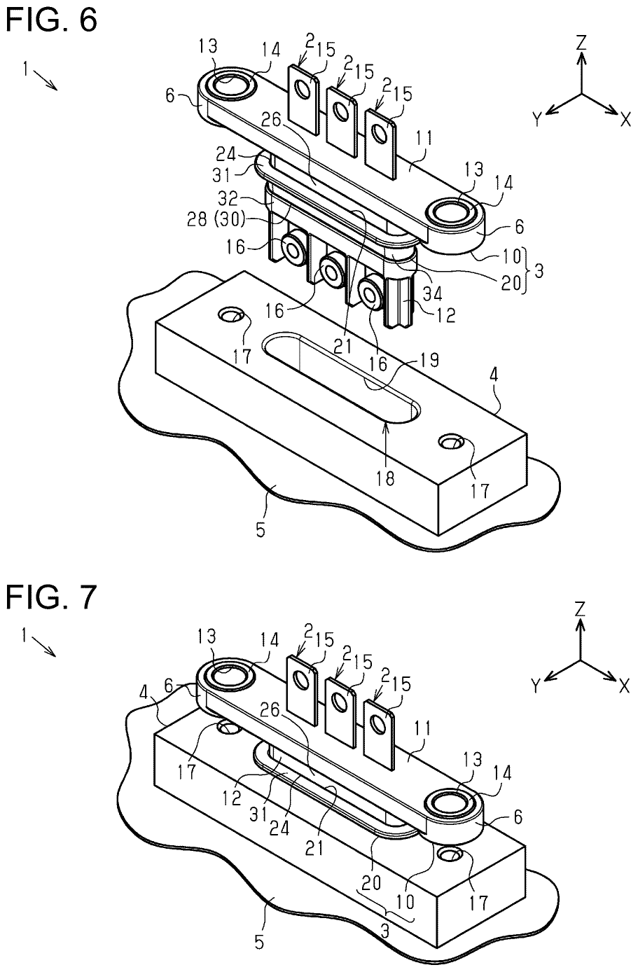

As shown in FIG. 6, when attaching the terminal block 3 to the attachment portion 4 of the case 5, first, the terminal block 3 with the elastic member 20 attached thereto is prepared. At this time, the elastic member 20 is placed on the seat portion 32 of the terminal block body 10. In other words, the terminal block 3 is in an initial state in which the attached elastic member 20 is placed on the seat portion 32.

Subsequently, as shown in FIG. 7, the terminal block 3 with the elastic member 20 attached thereto is attached to the attachment portion 4 of the case 5. Specifically, the terminal block 3 is fitted to the attachment portion 4 by inserting the second body 12 of the terminal block 3 into the recessed portion 18 of the attachment portion 4. Here, the terminal block 3 is inserted into the recessed portion 18 of the attachment portion 4 until the catch portion 31 of the elastic member 20 comes into contact with the upper surface of the attachment portion 4.

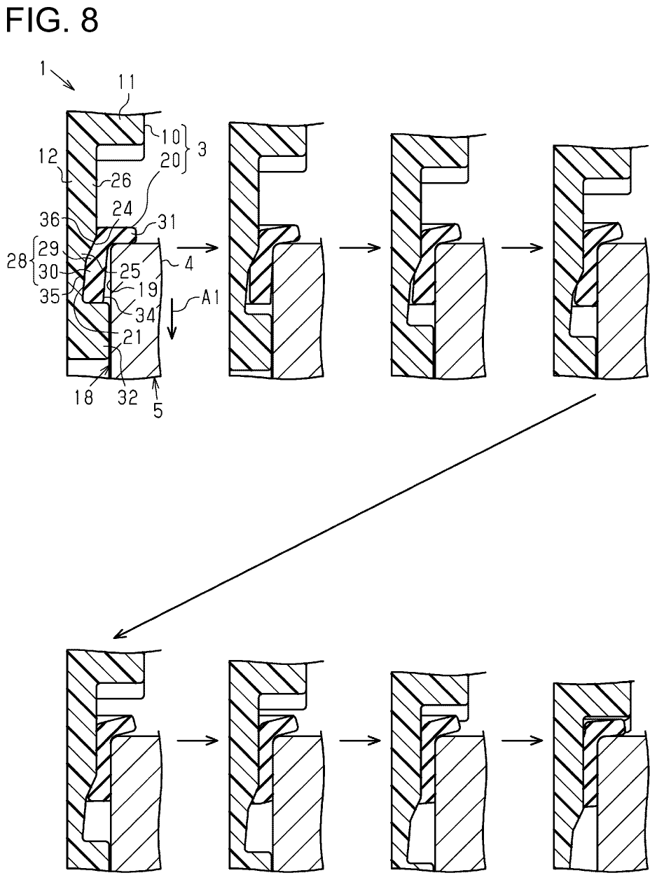

Then, as shown in FIG. 8, after the terminal block 3 is attached in the state shown in FIG. 7, the terminal block 3 is inserted further into the recessed portion 18 (in the arrow A1 direction). At this time, the elastic member 20 is squashed from the rear side by the protrusion portion 24 and pressed against the attachment surface 19 while undergoing elastic deformation.

In this example, when the protrusion portion 24 pushes the compression portion 28 from the rear side, the compression portion 28 moves in a direction orthogonal to the attachment direction (the arrow A1 direction) and comes into contact with the flat attachment surface 19. Then, as the terminal block 3 is inserted in the attachment direction (arrow A1 direction), the elastic member 20 does not move in the attachment direction of the terminal block 3 (arrow A1 direction), but undergoes elastic deformation while being further pressed by the sliding protrusion portion 24, and comes into close contact with the attachment surface 19 of the attachment portion 4.

Also, in the case of this example, the force point P1, at which a load is applied to the elastic member 20 by the protrusion portion 24, and the support point P2, at which the elastic member 20 moves due to the load, are offset from each other in the attachment direction of the terminal block 3 (arrow A1 direction). Therefore, when the terminal block 3 is attached, the elastic member 20 rotates about the support point P2, and the compression portion 28 comes into forceful close contact with the attachment surface 19.

During the process of attaching the terminal block 3, the compression portion 28 of the elastic member 20 is squashed by the flat pressing portion 26 of the protrusion portion 24. Specifically, the elastic member 20 is sandwiched between two flat surfaces, namely the flat pressing portion 26 and the attachment surface 19, so as to be squashed and tightly held therebetween. When the terminal block 3 is inserted to the deepest point in the recessed portion 18, the elastic member 20 is firmly pressed against the attachment surface 19 by substantially the entirety of the pressing portion 26. After the terminal block 3 is inserted to the deepest point, the terminal block 3 is fixed to the attachment portion 4 using the fastening portions 7.

Issues With Surface Sealing Structure In the case of this type of terminal block 3, surface sealing can be used for the sealing structure between the terminal block 3 and the attachment portion 4. The surface sealing structure is a structure in which, for example, the attachment portion 4 of the case 5 is subjected to surface processing, and a rubber packing provided on the terminal block 3 is pressed against and attached to the surface processed portion with a certain amount of pressure. In the case of surface sealing, it has been necessary to perform insert molding with an iron plate in the terminal block 3 in order to ensure surface pressure at the sealing surface. Therefore, in the case of surface sealing, there are problems of increased cost, increased size, and increased mass.

### Advantages of Structure of Present Disclosure

On the other hand, in the case of this example, the sealing structure of the terminal block 3 and the attachment portion 4 is a shaft sealing structure as described above. In the case of shaft sealing, there is no need for the iron plate that is required with surface sealing. Therefore, in the case of the terminal block 3 of this example, it is possible to reduce cost, reduce the size, and reduce the weight compared to the case of surface sealing. Also, if shaft sealing is used, the opening of the attachment portion 4 can be made smaller than in the case of surface sealing.

Furthermore, in the elastic member 20 attachment structure of this example, the elastic member 20 is pressed from the rear side by the protrusion portion 24 of the terminal block body 10 that moves in the attachment direction, and the elastic member 20 is squashed without moving in the attachment direction so as to be brought into close contact with the attachment surface 19. Therefore, the elastic member 20 does not need to slide on the attachment surface 19 during attachment. Therefore, even if the attachment surface 19 is not subjected to surface processing and has a rough surface, the elastic member 20 can be firmly brought into contact with the attachment surface 19 without damaging the elastic member 20. It is thus possible to provide the elastic member 20 with high sealing performance. Furthermore, since there is no need to subject the attachment surface 19 to surface processing, it is also possible to reduce the processing cost.

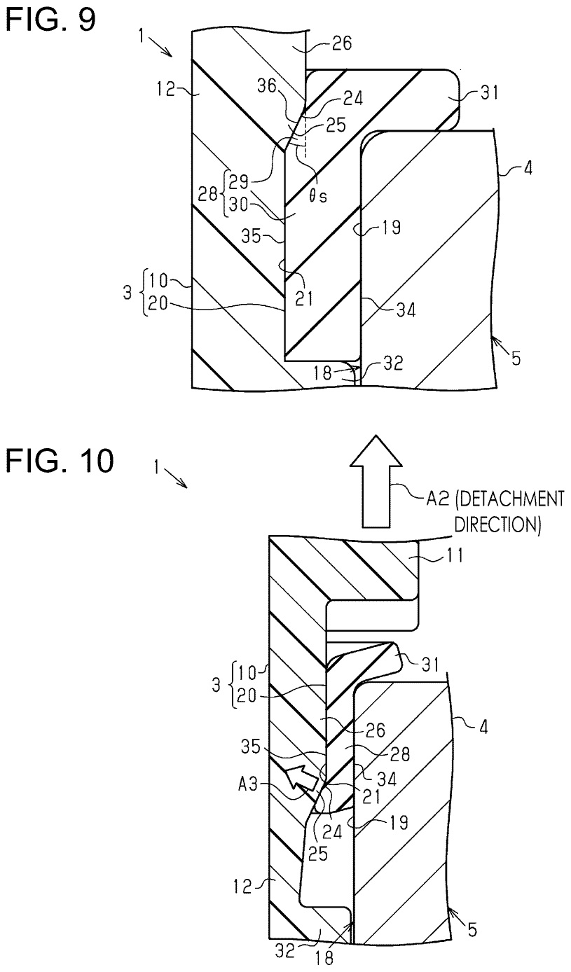

Here, as shown in FIG. 9, consider a case where the elastic member 20 is shaped such that the compression portion 28 does not form the angle θr, for example. In other words, assume that the elastic member 20 is shaped such that the compression portion 28 extends at a right angle to the catch portion 31. In this case, the compression portion 28 is in contact with the attachment surface 19 even before attachment. Therefore, during attachment, there is less space for the compression portion 28 to undergo elastic deformation, and thus force is required when inserting the terminal block 3 into the recessed portion 18. Therefore, in order to make it possible to insert the terminal block 3 with an appropriate load, an incident angle θs of the elastic member 20 needs to be reduced. Note that the incident angle θs is the angle of the inclined surface 36 at the base end portion 29, for example.

However, when the incident angle θs of the elastic member 20 is made smaller, the inclined surface portion 25 needs to have a larger area, and the area of the pressing portion 26 becomes smaller accordingly. If the area of the pressing portion 26 decreases, the amount of surface pressure when the protrusion portion 24 squashes the elastic member 20 from the rear side decreases, thus leading to the possibility that the necessary sealing performance cannot be ensured.

On the other hand, as shown in FIG. 2, in this example, the elastic member 20 is shaped such that the compression portion 28 forms the angle θr. In other words, the elastic member 20 is shaped such that the compression portion 28 extends obliquely with respect to the catch portion 31. Therefore, it is possible to reduce the incident angle θs of the elastic member 20 without significantly changing the area of the pressing portion 26 of the protrusion portion 24. Therefore, it is possible to both firmly fix the elastic member 20 to the attachment surface 19 and smoothly attach the terminal block 3 with appropriate force.

Here, as shown in FIG. 10, after the terminal block 3 is attached to the attachment portion 4, a load may be applied in a detachment direction of detachment of the terminal block 3 from the attachment portion 4 (arrow A2 direction). In view of this, in the case of this example, the distal end of the compression portion 28 has a quadrangular shape in cross section. Therefore, in the case where the terminal block 3 attempts to move in a direction of detachment from the attachment portion 4, it is possible to generate repulsive force acting in an oblique direction (arrow A3 direction in the figure) in the distal end of the elastic member 20. Therefore, it is possible to keep the elastic member 20 in place and make it difficult for the elastic member 20 to detach unintentionally.

### Effects of Embodiment

According to the terminal block 3 (terminal block unit 1) of the above embodiment, effects such as the following can be obtained.
(1) A terminal block 3 includes a terminal block body 10 and an elastic member 20. The terminal block body 10 has one or more terminals 2 each having two ends serving as electrical connection points, and is configured to be attached to a case 5 by being fitted to an attachment portion 4 of the case 5. The elastic member 20 is arranged to seal a connection between the attachment portion 4 and the terminal block body 10, and has an annular shape. The terminal block body 10 further includes a protrusion portion 24 configured to press and fix the elastic member 20 against a flat attachment surface 19 of the attachment portion 4 without moving the elastic member 20 in an attachment direction during attachment to the attachment portion 4. The elastic member 20 includes a compression portion 28 configured to be squashed and pressed against the attachment surface 19 by the protrusion portion 24 during attachment.

According to the configuration of this example, when the terminal block 3 is attached, the elastic member 20 is fixed to the attachment surface 19 by being squashed by the protrusion portion 24 of the terminal block body 10 without moving in the attachment direction. In this way, in this example, a structure is adopted in which the elastic member 20 is attached while being pressed against the attachment surface 19 and undergoing elastic deformation. Therefore, during attachment, the elastic member 20 does not slide on the surface of the attachment surface 19. This therefore suppresses, for example, a problem that may occur when the case 5 is a cast product, that is to say a situation in which, during attachment, the elastic member 20 is damaged by a cavity that appears due to sealing surface processing. Therefore, the sealing performance between the terminal block 3 and the case 5 can be improved.
(2) The elastic member 20 further includes a catch portion 31 configured to be caught on an upper surface of the attachment portion 4 during attachment. According to this configuration, during attachment, the catch portion 31 of the elastic member 20 can be caught on the attachment portion 4, and the elastic member 20 can be positioned in the attachment direction. Therefore, it is possible to suppress the occurrence of a situation in which the elastic member 20 moves in the attachment direction during attachment.
(3) The protrusion portion 24 has a force point P1 at which the elastic member 20 is pressed against the attachment surface 19 during attachment. The catch portion 31 has a support point P2 of movement of the compression portion 28 in elastic deformation due to being pressed by the protrusion portion 24 at the force point P1. In an initial state before attachment, the force point P1 is located on a near side in the attachment direction and the support point P2 is located on a far side in the attachment direction. According to this configuration, when the elastic member 20 is pressed by the protrusion portion 24 at the force point P1 during attachment, it is possible to press the elastic member 20 against the attachment surface 19 with the support point P2 of the catch portion 31 serving as the basis. Therefore, during attachment, the elastic member 20 can be firmly fixed to the attachment surface 19 without being moved in the attachment direction.
(4) The terminal block body 10 further includes a seat portion 32 on which a distal end of the compression portion 28 is placed in an initial state before attachment. According to this configuration, it is possible to suppress the case where the elastic member 20 separates from the terminal block body 10 before attachment.
(5) The protrusion portion 24 further includes a flat pressing portion 26 configured to, along with the attachment surface 19, sandwich and support the elastic member 20 during attachment. According to this configuration, the elastic member 20 can be sandwiched and held between the flat attachment surface 19 and the pressing portion 26. Therefore, the elastic member 20 can be attached and fixed in close contact between the attachment surface 19 and the protrusion portion 24 without any gaps. The sealing performance of the elastic member 20 is thus further improved.
(6) The protrusion portion 24 includes an inclined surface portion 25 configured to squash the compression portion 28 during attachment. According to this configuration, when the terminal block 3 is attached, the elastic member 20 can gradually undergo elastic deformation due to being pressed by the inclined surface portion 25 of the protrusion portion 24. Therefore, when fitting the terminal block 3 into the attachment portion 4, no excessive load is applied, and thus the terminal block 3 can be smoothly attached to the attachment portion 4 with appropriate force.
(7) The compression portion 28 includes a base end portion 29 having an inclined surface 36 configured to come into contact with the inclined surface portion 25 of the terminal block body 10, and a thick wall portion 30 extending distally from the base end portion 29 and thicker than the base end portion 29. According to this configuration, the thick wall portion 30 is provided in the compression portion 28, thus making it possible to provide a larger area of engagement when the protrusion portion 24 of the terminal block body 10 comes into contact during attachment. Therefore, it is possible to firmly bring the elastic member 20 into close contact with the attachment portion 4 of the case 5. This therefore further contributes to improving the sealing performance of the elastic member.
(8) The thick wall portion 30 includes a first contact surface 34 configured to come into contact with the attachment surface 19 during attachment, and a second contact surface 35 on the side opposite to the first contact surface 34 and configured to come into contact with the terminal block body 10 during attachment. The second contact surface 35 is longer than the inclined surface 36 in an axial direction of the elastic member 20. According to this configuration, the second contact surface 35 of the elastic member 20 can be larger, thus making it possible to ensure a sufficient amount of surface pressure applied to the elastic member 20 by the protrusion portion 24 during attachment. This further contributes to firmly attaching the elastic member 20 to the attachment surface 19.
(9) The compression portion 28 is non parallel with the attachment surface 19 so as to form an angle θr with the attachment surface 19. According to this configuration, the elastic member 20 is shaped such that the compression portion 28 is closer to the terminal block body 10. Therefore, the incident angle θs, which is the angle formed by the attachment surface 19 of the attachment portion 4 and the inclined surface 36 of the elastic member 20, can be made smaller without greatly changing the area of the pressing portion 26, which is the portion of the protrusion portion 24 that presses the elastic member 20. Therefore, it is possible to both firmly fix the elastic member 20 to the attachment surface 19 and smoothly attach the terminal block 3 with appropriate force.
(10) A distal end of the compression portion 28 has a quadrangular shape in cross section. According to this configuration, in the case where the terminal block 3 attempts to move in a direction of detachment from the attachment portion 4, it is possible to generate, in the distal end of the elastic member 20 (compression portion 28), repulsive force acting in an oblique direction (arrow A3 direction in FIG. 10) for pressing the distal end against the terminal block body 10. Therefore, even if the terminal block 3 attempts to move in a direction of detachment from the attachment portion 4, the elastic member 20 can be kept in place. The sealing performance of the elastic member 20 is thus further improved.

### Other Examples

Note that the present embodiment can be implemented with modifications such as the following. The above embodiments and the following modified examples can be implemented in combination with each other as long as no technical contradiction arises.

The fitting of the terminal block 3 and the attachment portion 4 is not limited to internal fitting in which the terminal block 3 is fitted into the attachment portion 4 at the sealing location, and instead may be external fitting in which the terminal block 3 is fitted around the attachment portion 4 at the sealing location.
The number of terminals 2 is not limited to three, and may be any other number.
The elastic member 20 may be attached to the attachment portion 4 instead of the terminal block body 10 in the initial state.
The shape of the annular elastic member 20 may be changed to another shape such as a perfect circular shape or a quadrangular shape when viewed along the axial direction of the elastic member 20, for example.
The compression portion 28 of the elastic member 20 may extend in a direction orthogonal to the catch portion 31.
The catch portion 31 may be omitted from the elastic member 20.
The base end portion 29 of the elastic member 20 is not limited to having the inclined surface 36, and may instead have a shape in which the inclined surface 36 extends straight along the attachment direction.
The elastic member 20 is not required to form the angle θr with respect to the attachment surface 19.
The distal end of the elastic member 20 (compression portion 28) may be trimmed to a tapered shape, for example, to promote elastic deformation.
The protrusion portion 24 is not limited to having the inclined surface portion 25, and may be a stepped portion having a step-like shape, for example.
The protrusion portion 24 may have any shape as long as it can squash and elastically deform the elastic member 20.
The seat portion 32 is not limited to extending completely around the terminal block body 10 in the peripheral direction, and may instead be provided only intermittently at predetermined locations.
The first contact surface 34 and the second contact surface 35 are not limited to being parallel with each other, and may instead be non parallel.
The case 5 (attachment portion 4) is not limited to being a cast product, and may instead be a member formed using another material or construction method.
As shown in FIGS. 3 and 4, in the second body 12 of the terminal block body 10, the portion thereof to which the elastic member 20 is attached may have, for example, the pressing portion 26, a constricted portion with an outer diameter smaller than the pressing portion 26, and the inclined surface portion 25 connecting the pressing portion 26 and the constricted portion. The elastic member 20 may be attached to the second body 12 of the terminal block body 10 such that, for example, the inner peripheral surface comes into close contact with the outer peripheral surfaces of the pressing portion 26, the inclined surface portion 25, and the constricted portion.
As shown in FIG. 4, the outer peripheral surface of the inclined surface portion 25, the outer peripheral surface of the constricted portion, and the outer peripheral surface of the elastic member 20 (first contact surface 34) may be inclined with respect to the axial direction L1 of the elastic member 20 such that the outer diameters of the outer peripheral surfaces become smaller while extending in the attachment direction A1 in which the terminal block 3 is attached to the attachment portion 4, for example. For example, the outer peripheral surface of the constricted portion may be inclined with respect to the axial direction L1 of the elastic member 20 at an angle smaller than that of the inclined surface portion 25.
As shown in FIGS. 4, 7, and 8, a configuration is possible in which, when the elastic member 20 attached to the terminal block 3 is inserted into the recessed portion 18 of the attachment portion 4 until the catch portion 31 of the elastic member 20 comes into contact with the upper surface of the attachment portion 4 (state shown in FIGS. 4 and 7), the elastic member 20 does not move relative to the terminal block 3, the outer peripheral surface of the compression portion 28 of the elastic member 20 does not come into contact with the inner peripheral surface (attachment surface 19) of the recessed portion 18, and the elastic member 20 is in the natural state of not being squashed. The distance between the outer peripheral surface of the compression portion 28 of the elastic member 20 and the inner peripheral surface (attachment surface 19) of the recessed portion 18 may increase in the attachment direction A1 in which the terminal block 3 is attached to the attachment portion 4. The distance between the inner peripheral surface (attachment surface 19) of the recessed portion 18 and the outer peripheral surface of the pressing portion 26 may be smaller than the thickness of the compression portion 28 of the elastic member 20.
As shown in FIG. 8, a configuration is possible in which, when the terminal block 3 is inserted further into the recessed portion 18 (attachment direction A1) from the state shown in FIGS. 4 and 7, the catch portion 31 of the elastic member 20 is supported by the upper surface of the attachment portion 4, and the terminal block 3 moves relative to the elastic member 20, the compression portion 28 of the elastic member 20 is pressed against the inner peripheral surface (attachment surface 19) of the recessed portion 18 by the inclined surface portion 25 and undergoes elastic deformation while being squashed so as to elongate in the attachment direction A1.
Although the present disclosure has been described based on embodiments, it is understood that the present disclosure is not limited to the embodiments or structures. The present disclosure also includes various modified examples and equivalent modifications. Also, various combinations and configurations, as well as other combinations and configurations that include only one, more, or fewer elements, are encompassed within the range and scope of the idea of the present disclosure.

1. A terminal block comprising:
a terminal block body including one or more terminals each having two ends serving as electrical connection points, the terminal block body being configured to be attached to a case by being fitted to an attachment portion of the case; and
an annular elastic seal arranged to seal a connection between the attachment portion and the terminal block body, wherein:
the terminal block body further includes a protrusion configured to press and fix the elastic seal against a flat attachment surface of the attachment portion without moving the elastic seal in an attachment direction during attachment to the attachment portion, and
the elastic seal includes a compression portion configured to be squashed and pressed against the attachment surface by the protrusion portion-during attachment.

2. The terminal block according to claim 1,
wherein the elastic seal further includes a catch portion configured to be caught on an upper surface of the attachment portion during attachment.

3. The terminal block according to claim 2, wherein:
the protrusion has a force point at which the elastic seal is pressed against the attachment surface during attachment,
the catch portion has a support point of movement of the compression portion in elastic deformation due to being pressed by the protrusion at the force point, and
in an initial state before attachment, the force point is located on a near side in the attachment direction and the support point is located on a far side in the attachment direction.

4. The terminal block according to claim 1,
wherein the terminal block body further includes a seat on which a distal end of the compression portion is placed in an initial state before attachment.

5. The terminal block according to claim 1,
wherein the protrusion further includes a flat pressing portion configured to, along with the attachment surface, sandwich and support the elastic seal during attachment.

6. The terminal block according to claim 1,
wherein the protrusion includes an inclined surface configured to squash the compression portion during attachment.

7. The terminal block according to claim 6,
wherein the compression portion includes:
a base end having an inclined surface configured to come into contact with the inclined surface of the terminal block body; and
a thick wall extending distally from the base end and being thicker than the base portion end.

8. The terminal block according to claim 7, wherein:
the thick wall includes:
a first contact surface configured to come into contact with the attachment surface during attachment; and
a second contact surface on a side opposite to the first contact surface and configured to come into contact with the terminal block body during attachment, and
the second contact surface is longer than the inclined surface in an axial direction of the elastic seal.

9. The terminal block according to claim 1,
wherein the compression portion is non-parallel with the attachment surface so as to form an angle with the attachment surface.

10. The terminal block according to claim 1,
wherein a distal end of the compression portion has a quadrangular shape in cross section.

11. A terminal block unit comprising:
a terminal block body including one or more terminals each having two ends serving as electrical connection points; and
a case including an attachment portion to which the terminal block is attachable, wherein:
the terminal block includes:
a terminal block body configured to be attached to the case by being fitted to the attachment portion; and
an annular elastic seal arranged to seal a connection between the attachment portion and the terminal block body,
the terminal block body further includes a protrusion configured to press and fix the elastic seal against a flat attachment surface of the attachment portion without moving the elastic seal in an attachment direction during attachment to the attachment portion, and
the elastic seal includes a compression portion configured to be squashed and pressed against the attachment surface by the protrusion during attachment.
